(19) United States
(12) Patent Application Publication
(10) Pub. No.: US 2021/0123741 A1
(43) Pub. Date: Apr. 29, 2021

(54) Systems and Methods for Navigating Aerial Vehicles Using Deep Reinforcement Learning

(71) Applicant: LOON LLC, Mountain View, CA (US)

(72) Inventors: Salvatore J. Candido, Mountain View, CA (US); Jun Gong, Mountain View, CA (US); Marc Gendron-Bellemare, Montreal (CA); Marlos Cholodovskis Machado, Montreal (CA)

(73) Assignee: LOON LLC, Mountain View, CA (US)

(21) Appl. No.: 16/667,424

(22) Filed: Oct. 29, 2019

(51) Int. Cl. G01C 21/20; G06N 3/08; G06N 3/04

(52) U.S. Cl. CPC G01C 21/20; G06N 3/0427; G06N 3/08

(57) ABSTRACT

The technology relates to navigating aerial vehicles using deep reinforcement learning techniques to generate flight policies. A computing system may include a simulator configured to produce simulations of a flight of the aerial vehicle in a region of an atmosphere, a replay buffer configured to store frames of the simulations, and a learning module having a deep reinforcement learning architecture configured to, by a reinforcement learning algorithm, process an input of a set of frames, and output a neural network encoding a learned flight policy. A meta-learning system may include stacks of learning systems, a coordinator configured to provide an instruction to the learning systems that includes a parameter and a start time, and an evaluation server configured to evaluate resulting rewards from learned flight policies generated by the learning systems.

### CROSS-REFERENCE TO RELATED APPLICATIONS

This application is related to an application entitled “Systems and Methods for Navigating Aerial Vehicles Using Deep Reinforcement Learning,” filed Oct. 29, 2019, the contents of which are hereby incorporated by reference in their entirety.

### BACKGROUND OF INVENTION

Computing devices such as personal computers, laptop computers, tablet computers, cellular phones, and countless types of Internet-capable devices are increasingly prevalent in numerous aspects of modern life. This prevalence of Internet-capable devices can enable us to connect people all over the world, and as such, the demand for data connectivity via the Internet, cellular data networks, and other such networks, is growing rapidly. In areas where conventional Internet connectivity-enabling infrastructure exists (e.g., urban or other relatively densely populated areas), people can connect to make phone calls in an emergency, get access to the weather forecasts (e.g., to plan for crop planting, to plan logistics for major events, etc.) and to education. However, there are many areas of the world where data connectivity is unavailable, unreliable and/or extremely costly due to difficulties in building and maintaining conventional infrastructure in these areas. In these areas, the growing demand for data connectivity is not being met, thus they can benefit greatly from data connectivity delivered by fleets of aerial vehicles.

There are various types of aerial vehicles that may provide these types of connectivity services, floating or flying at different altitudes and regions of the atmosphere. Particularly, in the stratosphere where winds are stratified, wind currents are strong and quickly changing, and each layer of wind may vary in speed and direction, unmanned high altitude aerial vehicles may navigate from location to location using these stratospheric wind currents. However, many factors, in addition to predicted weather forecasts, are important in generating navigation policies for planning and/or controlling movement of such aerial vehicles. Conventional methods for generating flight controllers are unable to use large numbers of variable factors and objectives under uncertainty, such as imperfect weather forecasts, to optimize flight objectives. Typical flight controllers also have difficulty adapting to localized differences, such that a controller would not be tuned to optimize a vehicle's flight over two or more regions (e.g., over a country, island, ships, or bodies of water, near the equator versus another farther North, South, or closer to a pole) with different flight regulations, no-fly restrictions, and other environmental or regulatory differences.

Conventional flight navigation techniques have largely been unique to a particular type of vehicle and determined based on a combination of heuristics (i.e., rules) and conventional models. The particular set of heuristics and conventional models for determining flight paths and actions often will be tailored to a specific vehicle system, with a particular set of characteristics such as size, weight, materials, whether the vehicle is floating or self-propelled, or other characteristics. Thus, conventional techniques are unable to generate controllers for many different types of vehicles without a lot of custom human design, and generally require a significant amount of human engineering and tailoring to achieve each defined objective, much less to achieve multiple objectives at the same time, such as reaching a target destination while optimizing for power consumption, avoiding unauthorized airspace, and reducing time and/or distance to the target destination.

Thus, improved systems and methods for generating flight policies for aerial vehicle navigation that optimizes flight for a variety of aerial vehicles and across a variety of data sets is desirable.

### BRIEF SUMMARY

The present disclosure provides for a system and method for generating learned flight policies for aerial vehicles, and systems and methods for controlling flight of aerial vehicles using learned flight policies. A computing system for generating a learned flight policy for an aerial vehicle includes one or more computers and one or more storage devices, the one or more storage devices storing instructions that when executed cause the one or more computers to implement a simulator configured to produce a plurality of simulations of a flight of the aerial vehicle in a region of an atmosphere, a replay buffer configured to store a plurality of frames of the plurality of simulations, and a learning module comprising a deep reinforcement learning architecture configured to, by a reinforcement learning algorithm, process an input comprising a set of frames, and output a neural network encoding a learned flight policy.

In one example, a reward function is defined in the deep reinforcement architecture, the reward function being used by the learning module to score the learned flight policy. In another example, the reward function is defined in order to achieve an objective relating to navigation of the aerial vehicle. In another example, the reward function is defined in order to achieve an objective relating to an operation of the aerial vehicle. In another example, the system also includes a flight policy server configured to store the neural network encoding the learned flight policy. In another example, the system also includes an operation-ready policies server configured to store the neural network encoding the learned flight policy when the learned flight policy meets or exceeds an operation-ready or equivalent threshold score. In another example, each simulation of the plurality of simulations comprises a plurality of frames, and each frame of the plurality of frames represents a time step of a corresponding simulation. In another example, each frame comprises a feature vector representing a plurality of features of the corresponding simulation. In another example a subset of the plurality of features is an operational feature of the corresponding simulation. In another example, a subset of the plurality of features is an environmental feature of the corresponding simulation. In another example, the aerial vehicle is a high altitude lighter than air vehicle. In another example, the aerial vehicle is a high altitude fixed-wing vehicle. In another example, the replay buffer can provide an arbitrary subset of the plurality of frames to be randomly sampled by the learning module.

A meta-learning system for training a plurality of neural networks encoding a plurality of learned flight policies includes a plurality of learning systems, a coordinator configured to provide an instruction to each of the plurality of learning systems comprising a parameter and a start time, and an evaluation server configured to evaluate a resulting reward (i.e., sum of rewards) from a learned flight policy generated by one of the plurality of learning systems. Each learning system has a simulation module comprising a plurality of simulators configured to run flight simulations, a replay buffer configured to store a plurality of frames of the plurality of simulations and to provide an arbitrary subset of the plurality of frames to be randomly sampled, and a learning module including a deep reinforcement learning architecture, the learning module configured to process an input comprising a set of frames, and output a neural network encoding a learned flight policy, wherein the neural network is one of the plurality of neural networks encoding the plurality of learned flight policies.

In an example, the learning module can score the learned flight policy by a reward function corresponding to an objective of the learning system, one of the set of parameters being the objective. In another example, the meta-learning system also includes an operation-ready policies server configured to store the neural network encoding the learned flight policy when a reward score for the learned flight policy meets or exceeds an operation-ready or equivalent threshold.

A method for training a flight policy for an aerial vehicle includes simulating, by a simulation module comprising two or more simulators, an aerial vehicle's flight through a region of the atmosphere according to a flight policy; generating a plurality of frames, each frame representing a time step of a simulation produced by the two or more simulators; storing the plurality of frames, each frame including a feature vector characterizing a plurality of features and representing a given situation at the time step of the simulation; requesting, by a learning module implementing a reinforcement learning algorithm, a set of frames from the replay buffer; processing, by the learning module, the set of frames using the reinforcement learning algorithm; generating, by the learning module, a neural network encoding a learned flight policy; and storing the learned flight policy in a policy server, the flight policy being encoded in a neural network.

In one example, the method also includes evaluating the neural network encoding the learned flight policy according to a threshold. In another example, the set of frames is provided to the learning module in a random order. In another example, the learned flight policy is configured to output an action for the aerial vehicle in the given situation. In another example, the learned flight policy is configured to output a representation of an action for the aerial vehicle in the given situation. In another example, the learned flight policy is configured to output a command for the aerial vehicle in the given situation. In another example, at least one of the plurality of features is an operational feature of the simulation. In another example, at least one of the plurality of features is an environmental feature of the simulation.

An operational system for controlling flight of an aerial vehicle includes a computing system configured to process an input vector representing a state of the aerial vehicle and output an action; an operation-ready policies server configured to store a trained neural network encoding a learned flight policy; and a controller configured to control the aerial vehicle, wherein the computing system is configured to process the input vector using the trained neural network encoding the learned flight policy.

In one example, the learned flight policy is configured to determine the action for the aerial vehicle to perform in a given situation. In another example, the input comprises an input vector characterizing the given situation. In another example, the neural network encoding the learned flight policy has been trained using a learning system implementing a reinforcement learning algorithm, the learning system having assigned the learned flight policy a score that meets or exceeds an operation-ready or equivalent threshold. In another example, the trained neural network encoding the learned flight policy is configured to achieve an objective. In another example, the system also includes a flight computer configured to convert the action into a set of commands configured to cause the aerial vehicle to perform the action. In another example, the controller has a logic circuit configured to implement the set of commands. In another example, the aerial vehicle is a lighter than air type vehicle. In another example, the aerial vehicle is a fixed-wing type vehicle.

A method for navigating an aerial vehicle includes selecting a trained neural network encoding a learned flight policy from an operation policies server; generating an input vector comprising a set of characteristics representing a state of the aerial vehicle; selecting an action, by the trained neural network, based on the input vector; converting the action into a set of commands, by a flight computer, the set of commands configured to cause the aerial vehicle to perform the action; and causing, by a controller, the aerial vehicle to perform the action using the set of commands.

In one example, the method also includes determining whether to continue operation of the aerial vehicle. In another example, the method also includes, after determining to continue operation of the aerial vehicle, generating another input vector representing a current state of the aerial vehicle, selecting a next action, by the trained neural network, based on the other input vector, and causing, by the controller, the aerial vehicle to perform the next action. In another example, the input vector further includes a set of characteristics representing a state of an environment surrounding the aerial vehicle. In another example, the environment is a region of the stratosphere, and the aerial vehicle is a high altitude aerial vehicle. In another example, the trained neural network encoding the learned flight policy is configured to select actions to achieve an objective. In another example, the objective comprises causing the aerial vehicle to spend an optimal (e.g., maximum, desired, predetermined) amount of time within a predetermined radius of a target location. In another example, the objective includes causing a group of aerial vehicles to provide connection services for a maximum amount of time to a geographical area, wherein the aerial vehicle is one of the group of aerial vehicles. In another example, the objective includes causing the aerial vehicle to arrive at a target location at a desired date and time. In another example, the objective includes optimizing the aerial vehicle's power consumption while the aerial vehicle navigates to a target location.

### BRIEF DESCRIPTION OF THE DRAWINGS

FIGS. 1A-1B are diagrams of exemplary operational systems in which learned flight policies may be implemented for navigating an aerial vehicle, in accordance with one or more embodiments;

FIG. 2 is a diagram of an exemplary aerial vehicle network, in accordance with one or more embodiments;

FIG. 3 is a simplified block diagram of an exemplary computing system forming part of the systems of FIGS. 1A-2, in accordance with one or more embodiments;

FIG. 4 is a simplified block diagram of an exemplary distributed computing system, in accordance with one or more embodiments;

FIG. 5A is a simplified block diagram of an exemplary flight policy training system, in accordance with one or more embodiments;

FIG. 5B is a simplified block diagram of another exemplary flight policy training system, in accordance with one or more embodiments;

FIG. 6 is a simplified block diagram of an exemplary meta-learning system, in accordance with one or more embodiments;

FIG. 7A is a flow diagram of an exemplary method for generating learned flight policies, in accordance with one or more embodiments;

FIG. 7B is a flow diagram of an exemplary method for evaluating learned flight policies and learning systems, in accordance with one or more embodiments;

FIG. 8 is a flow diagram of an exemplary method for deploying a learned flight policy in an operational aerial vehicle system, in accordance with one or more embodiments; and

FIG. 9 is a map showing a flight path resulting from controlling an aerial vehicle using a learned flight policy, in accordance with one or more embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The above and other needs are met by the disclosed methods, a non-transitory computer-readable storage medium storing executable code, and systems for navigating aerial vehicles in operation, as well as for generating flight policies for such aerial vehicle navigation using deep reinforcement learning.

Aspects of the present technology are advantageous for high altitude systems (i.e., systems that are operation capable in the stratosphere, approximately at or above 7 kilometers above the earth's surface in some regions, and at or above 20 kilometers above the earth's surface in other regions, or beyond in the exosphere or cosmic space), such as High Altitude Platforms (HAPs), High Altitude Long Endurance (HALE) aircraft, unmanned aerial vehicles (UAVs), including lighter than air vehicles (e.g., floating stratospheric balloons), propelled lighter than air vehicles (e.g., propelled floating stratospheric balloons), fixed-wing vehicles (e.g., drones, rigid kites), various types of satellites, and other high altitude aerial vehicles. In some examples, high altitude systems are configured to fly above an altitude reserved for commercial airline flights. One way to provide enhanced network access is through a network of aerial vehicles carrying Internet, cellular data, or other network capabilities. To maintain a network, each aerial vehicle in a fleet or network of aerial vehicles may travel to a particular location. In some embodiments, lighter than air aerial vehicles (i.e., propelled or not) may rely on rapidly changing and extreme (i.e., strong, high speed, and volatile) wind conditions to assist in navigation efforts to different locations. Other environmental and non-environmental factors may impact an aerial vehicle's flight plan or policy. In view of this, large scale simulations may be performed to evaluate operational characteristics or capabilities (e.g., power system availability, ambient temperatures, software and hardware versions implemented or accessible onboard, integrity of various components) and life cycle of individual aerial vehicles or fleets. Such simulations may be used to manage the life cycle of an aerial vehicle to manage risk of failures and to optimize availability for service delivery.

This disclosure is directed to a deep reinforcement learning system (hereinafter “learning system”) for generating optimal flight policies to control aerial vehicles according to a desired goal (i.e., objective), along with methods for performing training learned flight policies that are improved and optimized for one or more objectives, and deploying said learned flight policies in an aerial vehicle navigation system. As described in more detail below, the learning system comprises a simulation module (including one or more “Workers” or simulators), one or more replay buffers, a learning module comprising a deep reinforcement learning architecture designed to train flight policies, and one or more servers or repositories that store learned policies from the learning module.

In a training loop, the simulation module simulates an aerial vehicle's flight through a region of the atmosphere (e.g., stratosphere) according to a given policy (e.g., encoded into a neural network, for determining an action by the aerial vehicle in a given environment and aerial vehicle state). The simulation module generates a frame, represented by one or more feature vectors, for each time step, and feeds the frames of each simulation to one or more replay buffers. The replay buffers store the frames (e.g., in sequential order in a circular buffer or at random), and the learning module requests a set of frames from one or more replay buffers as inputs. An input may comprise a random sample of frames from a circular buffer, a prioritized sample of frames according to optimization criteria, or a set of frames with other characteristics.

The training loop continues with the learning module processing the frames according to a deep reinforcement learning architecture to determine, in a given situation (i.e., a given vehicle state in a given environment), which action provides a larger or largest estimated reward. Actions to be taken by an aerial vehicle may include ascending, descending, maintaining altitude, and propelling itself in a direction, among others, and may be manifested as discrete actions such as up, down, or stay (i.e., maintain altitude). In some examples, the learning module may run one or more neural networks that output a value or other representation of an action, or a command associated with an action, and a magnitude associated with said action or command. The deep reinforcement learning architecture may be configured to run one or more variations of reinforcement learning, including value-based methods, distributional methods, and policy-based methods. Some examples of reinforcement learning techniques include, without limitation, Q-learning, double Q-learning, distributional Q-learning, categorical Q-learning, quantile regression Q-learning; policy gradient, actor-critic, soft actor-critic, and trust region policy optimization, among others. The reinforcement learning algorithm in the learning module is characterized by a reward function corresponding to the objective of the flight policy training. The learning module generates learned flight policies (e.g., encoded in neural networks), and scores them according to the reward function. The learned policies may be stored in a policy server, from which the simulation module can pull learned policies to run further simulations.

A reward function is defined according to a desired objective. Example objectives include: flying within a predetermined radius of a target location; following a mapped trajectory; flying in a given direction; arriving at a location at a desired date and time; maximizing (or otherwise optimizing) the amount of time an aerial vehicle provides connection services to a given area; conserving energy or minimizing energy consumption during a time period of flight or in achieving any of the aforementioned objectives; and achieving any of the aforementioned objectives in coordination with other aerial vehicles (i.e., in the context of a fleet of aerial vehicles). In some examples, the systems described herein may be tuned with a reward function that optimizes for multiple objectives (e.g., any combination of the example objectives above), and may further account for other factors, such as minimizing wear on a vehicle, avoiding inclement weather, etc. A learned flight policy may be deemed high performing if it scores well according to the reward function, and threshold scores may be defined to determine whether a learned flight policy is high performing, low performing, operation-ready, or otherwise should be kept (i.e., stored for further use in simulations or operation) or discarded.

Multiple learning systems may be run in parallel as a meta-learning system, with varied parameters in each learning system. Parameters that may be varied may include: the reward function (e.g., objective being optimized, slope, additional factors, etc.), reward tuning or modification (e.g., period of time or times of day during which full reward is valid or awarded, penalties for various characteristics of simulation or resulting reward), the number of frames that a learning module requests per input, characteristics of said frames for input (e.g., random, prioritized, or other), the depth of the reinforcement learning architecture (e.g., number of layers, hidden or otherwise) in the learning module, number of objectives, types of objectives, number of available actions, types of available actions, length of time into the future that is being predicted, and more.

A learning system also may store high performing learned flight policies (i.e., store neural networks encoded with high performing flight policies) in a policy repository for use by an operational navigation system to control movement of an aerial vehicle according to one or more desired objectives. These high performing learned flight policies may be used to determine actions for an aerial vehicle in a given situation. In an embodiment described herein, an aerial vehicle system may generate an input vector characterizing a state of the aerial vehicle, which may be provided to a learned flight policy that processes the input vector to output an action optimized for an objective of the learned flight policy. Such input vectors may be generated onboard an aerial vehicle in some examples, and in other examples, may be generated offboard (e.g., in a datacenter, which may or may not be integrated with a ground station or other cloud infrastructure, or the like). The action may be converted to a set of commands configured to cause the aerial vehicle to perform the action. In some examples, the input vector may include more than an aerial vehicle's physical and operational state (e.g., battery levels, location, pose, speed, weight, dimensions, software version, hardware version, among others), but also may include one or more of the following environmental inputs: sensor inputs (e.g., measuring temperature, pressure, humidity, precipitation, etc.), weather forecasts, map information, air traffic information, date and time.

Using the systems and methods described herein, one can customize flight policies across vehicles types and also to particular environments (Peru vs. Ecuador vs. Kenya, if it is useful, for the same vehicle) to improve performance with minimal human interference. For example, a system can customize flight policies for particular countries, each with its own set of regulations and no-fly restrictions, as well as weather and wind forecasts specific to its region. Thus, these systems and methods for aerial vehicle navigation can generate controllers for many types of aerial vehicles with minimal custom human design. Also, for any given vehicle and environment, one can process more data, and more types of data, to generate improved controllers.

Example Systems

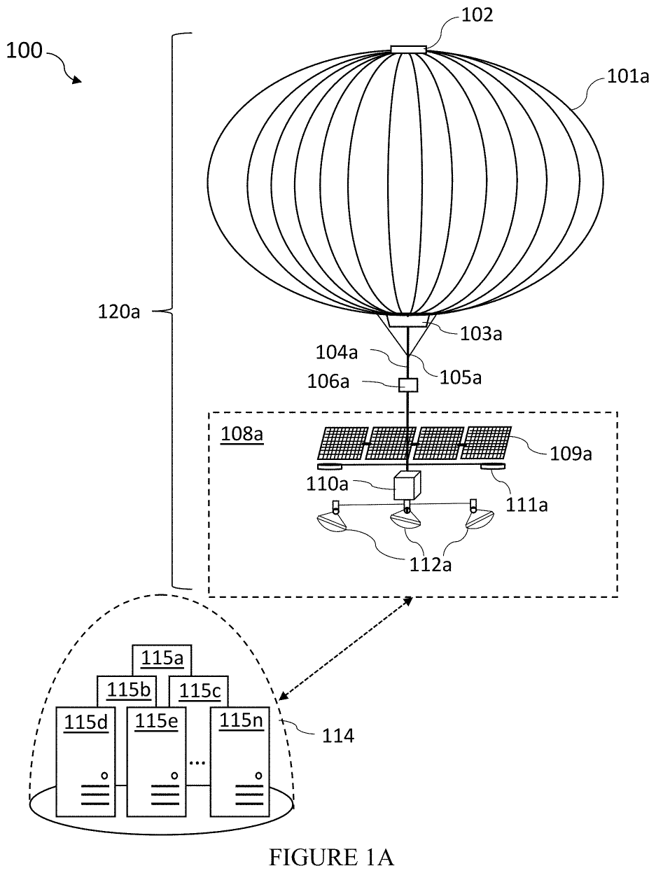

FIGS. 1A-1B are diagrams of exemplary operational systems in which flight policies may be implemented for navigating an aerial vehicle, in accordance with one or more embodiments. In FIG. 1A, there is shown a diagram of system 100 for navigation of aerial vehicle 120a. In some examples, aerial vehicle 120a may be a passive vehicle, such as a balloon or satellite, wherein most of its directional movement is a result of environmental forces, such as wind and gravity. In other examples, aerial vehicles 120a may be actively propelled. In an embodiment, system 100 may include aerial vehicle 120a and ground station 114. In this embodiment, aerial vehicle 120a may include balloon 101a, plate 102, altitude control system (ACS) 103a, connection 104a, joint 105a, actuation module 106a, and payload 108a. In some examples, plate 102 may provide structural and electrical connections and infrastructure. Plate 102 may be positioned at the apex of balloon 101a, and may serve to couple together various parts of balloon 101a. In other examples, plate 102 also may include a flight termination unit, such as one or more blades and an actuator to selectively cut a portion and/or a layer of balloon 101a. ACS 103a may include structural and electrical connections and infrastructure, including components (e.g., fans, valves, actuators, etc.) used to, for example, add and remove air from balloon 101a (i.e., in some examples, balloon 101a may include an interior ballonet within its outer, more rigid shell that is inflated and deflated), causing balloon 101a to ascend or descend, for example, to catch stratospheric winds to move in a desired direction. Balloon 101a may comprise a balloon envelope comprised of lightweight and/or flexible latex or rubber materials (e.g., polyethylene, polyethylene terephthalate, chloroprene), tendons (e.g., attached at one end to plate 102 and at another end to ACS 103a) to provide strength to the balloon structure, a ballonet, along with other structural components.

Connection 104a may structurally, electrically, and communicatively, connect balloon 101a and/or ACS 103a to various components comprising payload 108a. In some examples, connection 104a may provide two-way communication and electrical connections, and even two-way power connections. Connection 104a may include a joint 105a, configured to allow the portion above joint 105a to pivot about one or more axes (e.g., allowing either balloon 101a or payload 108a to tilt and turn). Actuation module 106a may provide a means to actively turn payload 108a for various purposes, such as improved aerodynamics, facing or tilting solar panel(s) 109a advantageously, directing payload 108a and propulsion units (e.g., propellers 107 in FIG. 1B) for propelled flight, or directing components of payload 108a advantageously.

Payload 108a may include solar panel(s) 109a, avionics chassis 110a, broadband communications unit(s) 111a, and terminal(s) 112a. Solar panel(s) 109a may be configured to capture solar energy to be provided to a battery or other energy storage unit, for example, housed within avionics chassis 110a. Avionics chassis 110a also may house a flight computer (e.g., computing device 301, as described herein), a transponder, along with other control and communications infrastructure (e.g., a controller comprising another computing device and/or logic circuit configured to control aerial vehicle 120a). Communications unit(s) 111a may include hardware to provide wireless network access (e.g., LTE, fixed wireless broadband via 5G, Internet of Things (IoT) network, free space optical network, or other broadband networks). Terminal(s) 112a may comprise one or more parabolic reflectors (e.g., dishes) coupled to an antenna and a gimbal or pivot mechanism (e.g., including an actuator comprising a motor). Terminal(s) 112(a) may be configured to receive or transmit radio waves to beam data long distances (e.g., using the millimeter wave spectrum or higher frequency radio signals). In some examples, terminal(s) 112a may have very high bandwidth capabilities. Terminal(s) 112a also may be configured to have a large range of pivot motion for precise pointing performance. Terminal(s) 112a also may be made of lightweight materials.

In other examples, payload 108a may include fewer or more components, including propellers 107 as shown in FIG. 1B, which may be configured to propel aerial vehicles 120a-b in a given direction. In still other examples, payload 108a may include still other components well known in the art to be beneficial to flight capabilities of an aerial vehicle. For example, payload 108a also may include energy capturing units apart from solar panel(s) 109a (e.g., rotors or other blades (not shown) configured to be spun by wind to generate energy). In another example, payload 108a may further include or be coupled to an imaging device, such as a downward-facing camera and/or a star tracker. In yet another example, payload 108a also may include various sensors (not shown), for example, housed within avionics chassis 110a or otherwise coupled to connection 104a or balloon 101a. Such sensors may include Global Positioning System (GPS) sensors, wind speed and direction sensors such as wind vanes and anemometers, temperature sensors such as thermometers and resistance temperature detectors, speed of sound sensors, acoustic sensors, pressure sensors such as barometers and differential pressure sensors, accelerometers, gyroscopes, combination sensor devices such as inertial measurement units (IMUs), light detectors, light detection and ranging (LIDAR) units, radar units, cameras, and more. These examples of sensors are not intended to be limiting, and those skilled in the art will appreciate that other sensors or combinations of sensors in addition to these described may be included without departing from the scope of the present disclosure.

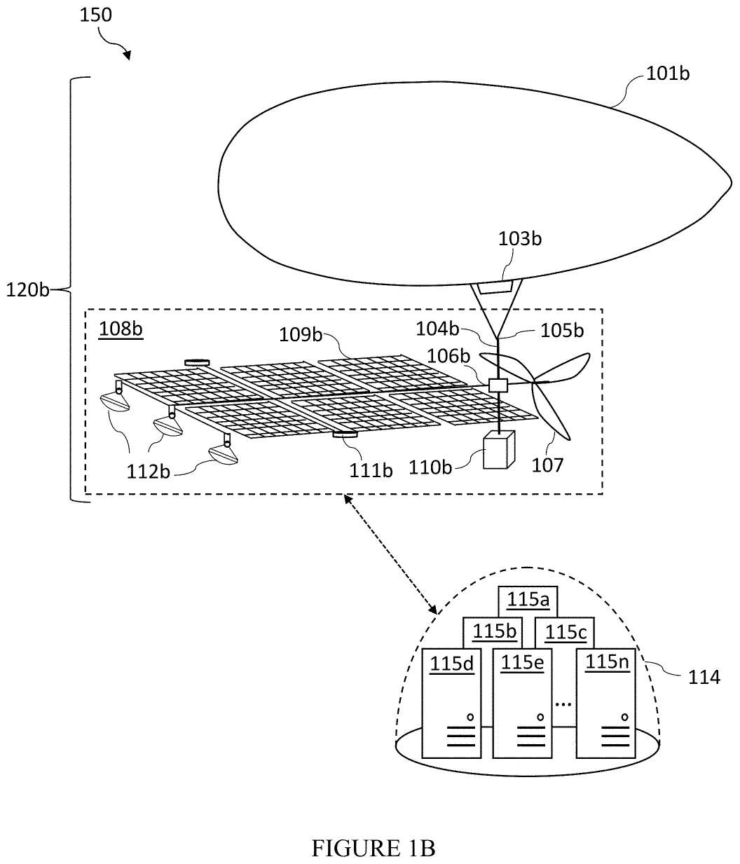

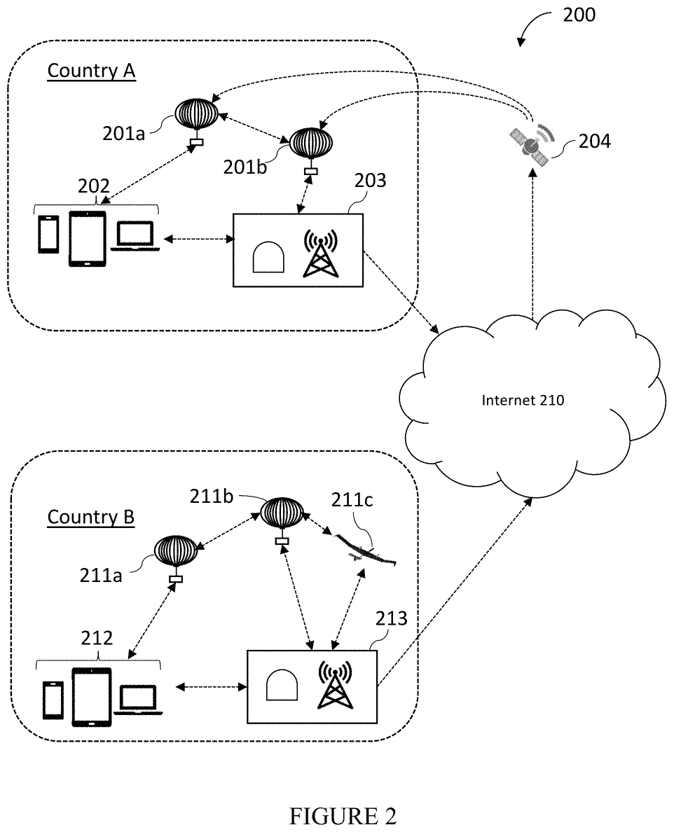

Ground station 114 may include one or more server computing devices 115a-n, which in turn may comprise one or more computing devices (e.g., computing device 301 in FIG. 3). In some examples, ground station 114 also may include one or more storage systems, either housed within server computing devices 115a-n, or separately (see, e.g., computing device 301 and repositories 320). Ground station 114 may be a datacenter servicing various nodes of one or more networks (e.g., aerial vehicle network 200 in FIG. 2).

FIG. 1B shows a diagram of system 150 for navigation of aerial vehicle 120b. All like-numbered elements in FIG. 1B are the same or similar to their corresponding elements in FIG. 1A, as described above (e.g., balloon 101a and balloon 101b may serve the same function, and may operate the same as, or similar to, each other). In this embodiment, aerial vehicle 120b further includes, as part of payload 108b, propellers 107, which may be configured to actively propel aerial vehicle 120b in a desired direction, either with or against a wind force to speed up, slow down, or re-direct, aerial vehicle 120b. In this embodiment, balloon 101b also may be shaped differently from balloon 101a, to provide different aerodynamic properties.

As shown in FIGS. 1A-1B, aerial vehicles 120a-b may be largely wind-influenced aerial vehicle, for example, balloons carrying a payload (with or without propulsion capabilities) as shown, or fixed wing high altitude drones (e.g., aerial vehicle 211c in FIG. 2). However, those skilled in the art will recognize that the systems and methods disclosed herein may similarly apply and be usable by various other types of aerial vehicles.

FIG. 2 is a diagram of an exemplary aerial vehicle network, in accordance with one or more embodiments. Aerial vehicle network 200 may include aerial vehicles 201a-b, user devices 202, and ground infrastructure 203, in Country A. Aerial vehicle network 200 also may include aerial vehicles 211a-c, user devices 212, and ground infrastructure 213 in Country B. Aerial vehicles 201a-b and 211a-c may comprise balloon, other floating (i.e., lighter than air), propelled or partially propelled (i.e., propelled for a limited amount of time or under certain circumstances, and not propelled at other times or under other circumstances), fixed-wing, or other types of high altitude aerial vehicles, as described herein. User devices 202 and 212 may include a cellular phone, tablet computer, smart phone, desktop computer, laptop computer, and/or any other computing device known to those skilled in the art. Ground infrastructure 203 and 213 may include always-on or fixed location computing device (i.e., capable of receiving fixed broadband transmissions), ground terminal (e.g., ground station 114), tower (e.g., a cellular tower), and/or any other fixed or portable ground infrastructure for receiving and transmitting various modes of connectivity described herein known to those skilled in the art. User devices 202 and 212, and ground infrastructure 203 and 213, all may be capable of receiving and transmitting signals to and from aerial vehicles 201a-b and 211a-c, as well as to and from each other. Aerial network 200 may further include satellite 204 and Internet 210. Aerial vehicles 201a-b and 211a-b may be the same or similar to aerial vehicles 120a-b described above. Aerial vehicle network 200 may support ground-to-vehicle communication and connectivity, as shown between ground infrastructure 203 and aerial vehicle 201b, as well as aerial vehicles 211b-c and ground infrastructure 213. In these examples, aerial vehicles 201b and 211b-c each may exchange data with either or both a ground station (e.g., ground station 114) and a tower. Aerial vehicle network 200 also may support vehicle-to-vehicle (e.g., between aerial vehicles 201a and 201b, between aerial vehicles 211a-c), satellite-to-vehicle (e.g., between satellite 204 and aerial vehicles 201a-b), and vehicle-to-user device (e.g., between aerial vehicle 201a and user devices 202, between aerial vehicle 211a and user devices 212), communication and connectivity. In some examples, ground stations within ground infrastructures 203 and 213 may provide core network functions, such as connecting to the Internet and core cellular data network (e.g., connecting to LTE EPC or other communications platforms, and a software defined network system) and performing mission control functions. In some examples, the ground-to-vehicle, vehicle-to-vehicle, and satellite-to-vehicle communication and connectivity enables distribution of connectivity with minimal ground infrastructure. For example, aerial vehicles 201a-b and 211a-c may serve as base stations (e.g., LTE eNodeB base stations), capable of both connecting to the core network (e.g., Internet and core cellular data network), as well as delivering connectivity to each other and to user devices 202 and 212. As such, aerial vehicles 201a-b and 211a-c represent a distribution layer of aerial vehicle network 200. User devices 202 and 212 each may access cellular data and Internet connections directly from aerial vehicles 201a-b and 211a-c.

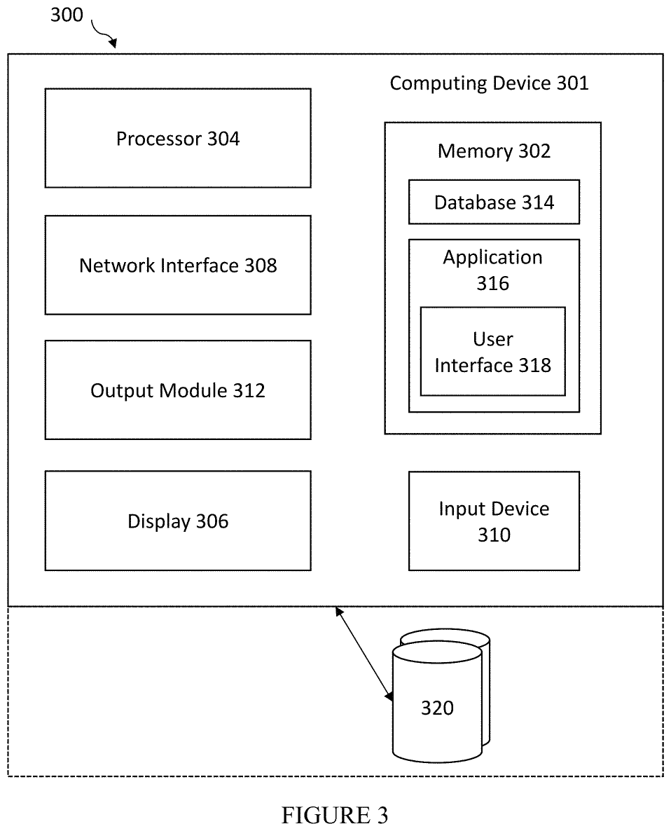

FIG. 3 is a simplified block diagram of an exemplary computing system forming part of the systems of FIGS. 1A-2, in accordance with one or more embodiments. In one embodiment, computing system 300 may include computing device 301 and storage system 320. Storage system 320 may comprise a plurality of repositories and/or other forms of data storage, and it also may be in communication with computing device 301. In another embodiment, storage system 320, which may comprise a plurality of repositories, may be housed in one or more of computing device 301. In some examples, storage system 320 may store learned flight policies, as described herein, and other various types of information as described herein. This information may be retrieved or otherwise accessed by one or more computing devices, such as computing device 301 or computing devices 401a-n in FIG. 4, in order to perform some or all of the features described herein. Storage system 320 may comprise any type of computer storage, such as a hard-drive, memory card, ROM, RAM, DVD, CD-ROM, write-capable, and read-only memories. In addition, storage system 320 may include a distributed storage system where data is stored on a plurality of different storage devices, which may be physically located at the same or different geographic locations (e.g., in a distributed computing system such as system 400 in FIG. 4). Storage system 320 may be networked to computing device 301 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 301 also may include a memory 302. Memory 302 may comprise a storage system configured to store a database 314 and an application 316. Application 316 may include instructions which, when executed by a processor 304, cause computing device 301 to perform various steps and/or functions, as described herein. Application 316 further includes instructions for generating a user interface 318 (e.g., graphical user interface (GUI)). Database 314 may store various algorithms and/or data, including neural networks (e.g., encoding flight policies, as described herein) and data regarding wind patterns, weather forecasts, past and present locations of aerial vehicles (e.g., aerial vehicles 120a-b, 201a-b, 211a-c), sensor data, map information, air traffic information, among other types of data. Memory 302 may include any non-transitory computer-readable storage medium for storing data and/or software that is executable by processor 304, and/or any other medium which may be used to store information that may be accessed by processor 304 to control the operation of computing device 301.

Computing device 301 may further include a display 306, a network interface 308, an input device 310, and/or an output module 312. Display 306 may be any display device by means of which computing device 301 may output and/or display data. Network interface 308 may be configured to connect to a network using any of the wired and wireless short range communication protocols described above, as well as a cellular data network, a satellite network, free space optical network and/or the Internet. Input device 310 may be a mouse, keyboard, touch screen, voice interface, and/or any or other hand-held controller or device or interface by means of which a user may interact with computing device 301. Output module 312 may be a bus, port, and/or other interface by means of which computing device 301 may connect to and/or output data to other devices and/or peripherals.

In some examples computing device 301 may be located remote from an aerial vehicle (e.g., aerial vehicles 120a-b, 201a-b, 211a-c) and may communicate with and/or control the operations of an aerial vehicle, or its control infrastructure as may be housed in avionics chassis 110a-b, via a network. In one embodiment, computing device 301 is a data center or other control facility (e.g., configured to run a distributed computing system as described herein), and may communicate with a controller and/or flight computer housed in avionics chassis 110a-b via a network. As described herein, system 300, and particularly computing device 301, may be used for planning a flight path or course for an aerial vehicle based on wind and weather forecasts to move said aerial vehicle along a desired heading or within a desired radius of a target location. Various configurations of system 300 are envisioned, and various steps and/or functions of the processes described below may be shared among the various devices of system 300, or may be assigned to specific devices.

FIG. 4 is a simplified block diagram of an exemplary distributed computing system, in accordance with one or more embodiments, comprising two or more computing devices 301a-n. In some examples, each of 301a-n may comprise one or more of processors 404a-n, respectively, and one or more of memory 402a-n, respectively. Processors 404a-n may function similarly to processor 304 in FIG. 3, as described above. Memory 402a-n may function similarly to memory 302 in FIG. 3, as described above.

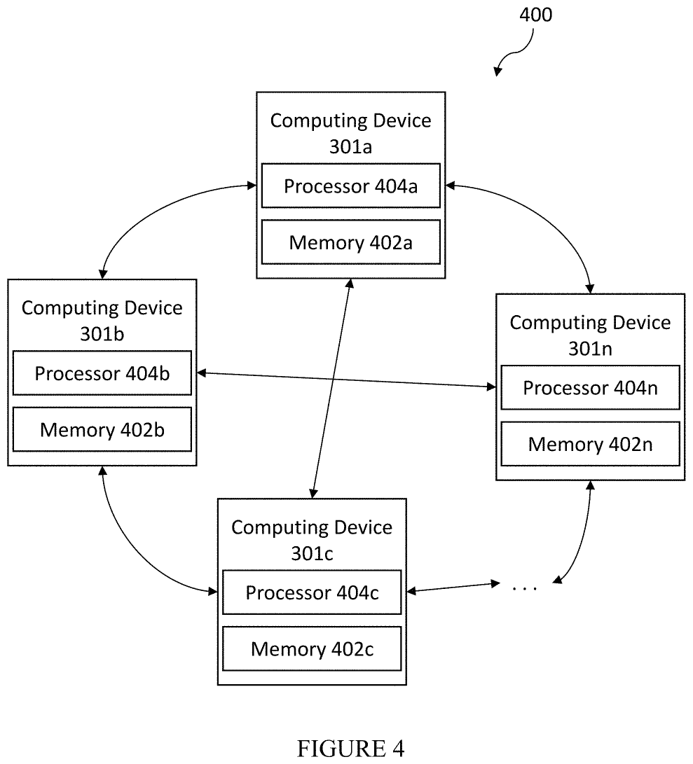

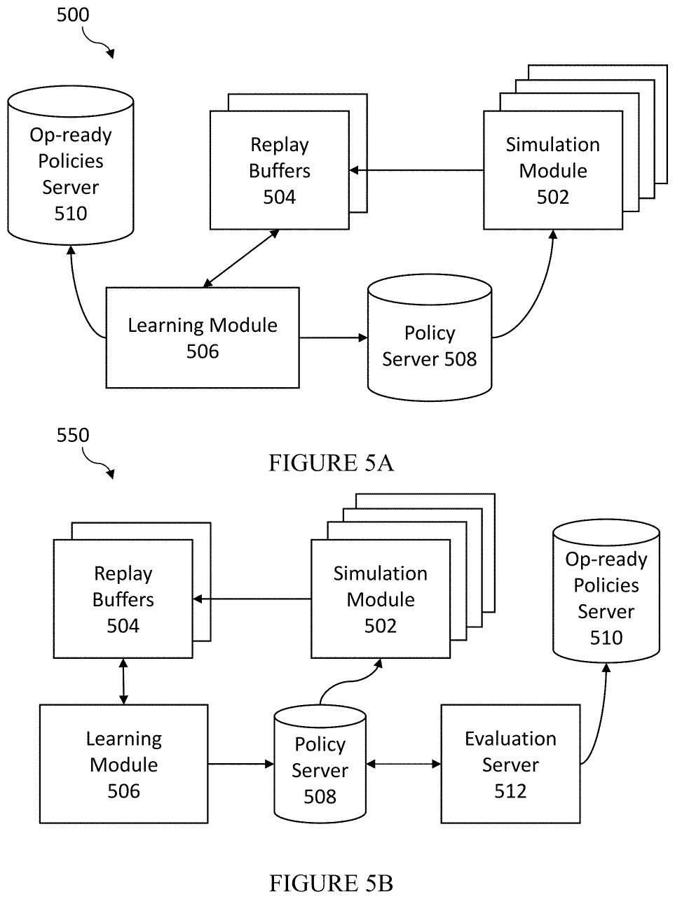

FIGS. 5A-5B are simplified block diagrams of exemplary flight policy training systems, in accordance with one or more embodiments. Flight policy training system 500 may include simulation module 502, one or more replay buffers 504, learning module 506, and policy server 508. Simulation module 502 may include one or more simulators configured to run flight simulations over and over. Each simulator is configured to generate feature vectors, and each simulation is characterized by a set of feature vectors, wherein actions taken in a time step of a simulation corresponds to a feature vector of a frame, and the resulting time step captured in the frame is associated with a reward for the behavior (i.e., the actions taken). When starting with an empty policy server 508, simulation module 502 may begin a simulation by randomly moving an aerial vehicle at random (e.g., up, down, maintaining altitude, etc.). In other examples, simulation module 502 may obtain an existing flight policy or learned flight policy (“existing policy”) from policy server 508, and run simulations according to said existing policy (i.e., using the existing policy to determine actions for an aerial vehicle in the simulation). Simulation module 502 may provide various inputs to said existing policy, including an input vector characterizing a state of the vehicle, as well as relevant weather data, onboard and offboard sensor data, and one or more desired objectives, in order to obtain actions to be taken by the aerial vehicle in the simulation. Each simulation produced by simulation module 502 may include a frame for each time step of the simulation. A frame comprises a feature vector (e.g., representing a given situation by characterizing one or more operational or environmental features of a simulation). Example operational and environmental features include an aerial vehicle's altitude (e.g., current pressure altitude), atmosphere contents (e.g., gases, liquids or solids that are present, ratio or percentages of said gases, liquids or solids, any other particles or contents), angle or heading to a target location, distance to a target location, angle of a wind current, wind speed at current altitude, view of a map of a geographic area surrounding the aerial vehicle, aerial vehicle speed and acceleration, ambient temperature, power stored in the aerial vehicle's battery, time of day (e.g., solar elevation), current or most recent action, mode of operation (e.g., low power mode, fallback mode, normal mode), among others. Feature vectors may be informed by various sources of data, including onboard and offboard sensors, maps, weather forecasts, and the like, as described herein.

Simulation module 502 may be configured to feed frames of simulations to replay buffers 504, which serve to randomize and store said frames independent of the particular simulations from which they came. A plurality of simulators in simulation module 502 (e.g., comprising several or ten or more simulators) may work to feed simulation frames to a plurality of replay buffers 504 (comprising one or more replay buffers).

Learning module 506 may be configured to pull sets of frames (e.g., comprising 32 or 64 frames, or any number of frames ranging from a dozen to multiples of fives, tens or dozens of frames) from replay buffers 504 to train learned flight policies. Learning module 506 may comprise a deep reinforcement learning architecture configured to run one or more variations of reinforcement learning, such as Q-learning, double Q-learning, distributional Q-learning, or other policy learning methods. The reinforcement learning algorithm in learning module 506 may be configured to maximize a sum of rewards generated by a reward function corresponding to the objective of the flight policy training. The reward function may be correlated with an objective (i.e., a control objective related to navigation or operation of an aerial vehicle, such as a high altitude aerial vehicle). Examples of objectives may include: following a map (e.g., following the gradient or map of a heuristic function built to indicate how to efficiently cross an ocean); spending the most (or otherwise optimal) amount of time within a radius of a target location (e.g., a latitude-longitude, a city, an island, a group or chain of islands, a group of buoyed structures such as offshore wind farms); following a mapped trajectory; flying in a given direction; arriving at a location at a desired date and time; maximizing (or otherwise optimizing) the amount of time an aerial vehicle provides connection services to a given area; following, or remaining within a given radius of, a terrestrial or nautical vehicle (e.g., a cruise ship, an all-terrain vehicle, etc.); and any of the above in coordination with other aerial vehicles (i.e., in the context of a fleet of aerial vehicles). Thresholds may be predetermined to categorize learned flight policies into various levels of performance (e.g., high, medium, or low performing) based on how a learned flight policy scores according to the reward function (i.e., how high of a reward produced by said learned flight policy). In some examples, the reward score may comprise a value. In other examples, where certain types of reinforcement learning is implemented (e.g., distributional Q-learning), a reward score may comprise a probability distribution or a distribution of rewards. In an example, learning module 506 may be configured to provide medium and high performing learned flight policies to policy server 508 for storage and further use by simulation module 502 to run simulations, and also to provide high performing learned flight policies to operation-ready policies server 510 for use in operational navigation systems, according to methods described below. In another example, learning module 506 may be configured to provide medium and high performing learned flight policies to policy server 508, and to provide a separate category of highest performing learned flight policies to operations policies server 510 for use in operational navigation systems. Learning module 506 may discard (i.e., delete) low-performing learned flight policies.

Turning to FIG. 5B, in an alternative embodiment, learning module 506 may store all learned flight policies in policy server 508, either ad hoc (i.e., as the learned flight policies are generated) or periodically (i.e., in batches), without regard to a resulting reward score. An evaluation server 512 may then retrieve the learned flight policies and evaluate the learned flight policies to determine whether they are operations ready (e.g., should be stored in operation-ready policies server 510). In some examples, evaluation server 512 may retrieve and evaluate every learned flight policy in policy server 508. In other examples, evaluation server 512 may retrieve and evaluate samples of the learned flight policies in policy server 508. In some examples, evaluation server 512 may run a set of simulations on the learned flight policies and use the resulting rewards to score the progress of learning by learning module 506. The set of simulations run by evaluation server 512 may be unchanging or consistent so as to evaluate each learned flight policy according to the same criteria.

In some examples, system 500 also may include an operation-ready policies server 510 separate from policy server 508, in which learned flight policies that meet or exceed a certain threshold score defined for an appropriate category of flight policies (e.g., high performing, highest performing, operation-ready, and other appropriate categories) may be stored. The operation-ready flight policies in operation-ready policies server 510 may be provided to aerial vehicles (e.g., aerial vehicles 120a-b, 201a-b, 211a-c) for navigation of said aerial vehicles (i.e., to determine actions to be performed by said aerial vehicles to achieve an objective), according to methods described in more detail below.

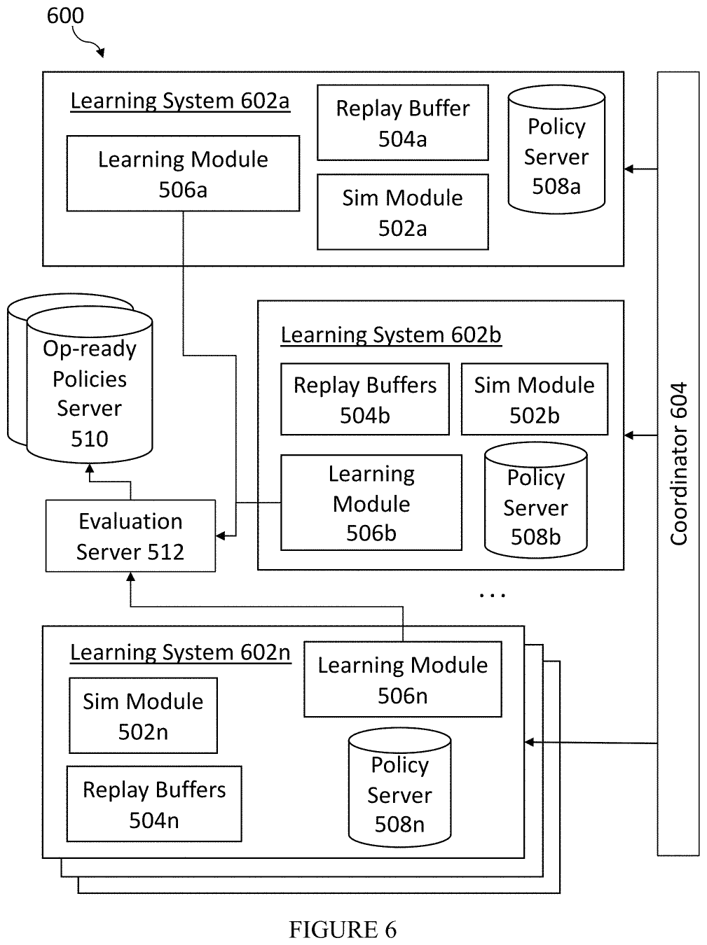

FIG. 6 is a simplified block diagram of an exemplary meta-learning system, in accordance with one or more embodiments. Meta-learning system 600 may comprise a plurality of learning systems 602a-n, coordinator 604, evaluation server 512, and operation-ready policies server 510. Each of learning systems 602a-n may include some or all of the same or similar components of flight policy training system 500. For example, learning systems 602a-n may include simulation modules 502a-n, replay buffers 504a-n, learning modules 506a-n, and policy servers 508a-n, respectively. In meta-learning system 600, a plurality (e.g., from a few to tens to 20-60, or more) of learning systems 602a-n may be run in parallel. In some examples, parameters may be varied among the plurality of learning systems 602a-n. Examples of parameters that may be varied among the plurality of learning systems 602a-n may include any of the parameters mentioned herein, for example in the context of learning systems 602a-n, without limitation: depth of (e.g., how many layers, hidden or otherwise) the reinforcement learning system within learning modules 506a-n; characteristics of a reward function (e.g., how steep is the slope of the function, how the function is defined according to an objective) by which learning modules 506a-n processes inputs; objective of the reward function (e.g., the objectives outlined herein, as well as variations on each objective); how many frames to include in each input to learning modules 506a-n; characteristics of the frames in each input to learning modules 506a-n; the feature vectors to be included in each input (i.e., input vector) to learning modules 506a-n; the number of replay buffers in each of buffers 504a-n; the number of simulators in each of simulation modules 502a-n; the reward score thresholds for discarding or storing a learned flight policy, for example in policy servers 508a-n and operation-ready policies server 510; the type of reinforcement learning being implemented in learning modules 506a-n; length of time into the future that is being predicted in each simulation; step size; and other parameters. Coordinator 604 may provide instructions to the various stacks (602a-c) on parameters to use and when to start and finish. In some examples, a learning system 602n may in itself comprise a stack of learning systems running on the same set of parameters.

In an example, a subset of 30-60 of learning systems 602a-n may be run in parallel with the objective of training optimal flight policies to navigate an aerial vehicle (e.g., aerial vehicles 120a-b, 201a-b, 211a-c) from a starting location to a target location. In this example, the objective amongst this subset of learning systems 602a-n may be the same, but each of learning systems 602a-n may be run with one or more of the following parameter variations: distances between said starting and target locations, the geographical locations of the starting and target locations (i.e., differing hemispheres or regions of the world, thereby invoking very different environmental conditions), starting times, number of frames per input (e.g., 16, 32, 64 or more), the reward function slope (i.e., how steep is the slope, which translates into how strictly the reward may be scored), number of simulators. In this example, said subset of 30-60 of learning systems 602a-n may further be grouped into subset groups, each subset group running variations on a single parameter or a few related parameters (e.g., a subset group running variations on the reward function, another subset group running variations on geographical locations, another subset group running variations on input vectors, etc.). In another example, another subset of learning systems 602a-n may be training on the same objective with the same parameter variations using a different type of reinforcement learning (e.g., Q-learning in one subset providing value scores, distributional Q-learning in another subset providing probability distribution scores). Evaluation server 512 may evaluate the performance of the learned flight policies being generated by learning systems 602a-n (e.g., retrieving from policy servers 508a-n or directly from learning modules 506a-n). Evaluation server 512 may determine which learned flight policies should be stored in operation-ready policies server 510, and provide feedback on which stacks are doing well or doing poorly. For example, where certain ones of said subset of 30-60 of learning systems 602a-n, characterized by certain sets of parameters, perform poorly (i.e., produce poor performing learned flight policies), the poor performing learning systems (i.e., sets of parameters) may be discontinued. As certain of learning systems 602a-n are discontinued, new ones with new sets of parameters may be added to particular subsets or subset groups.

In some examples, meta-learning system 600 may be implemented in a distributed computing environment wherein a plurality of copies of a stack of learning systems may be maintained along with a plurality of policy servers, each policy server being dedicated to a learning stack.

Example Methods

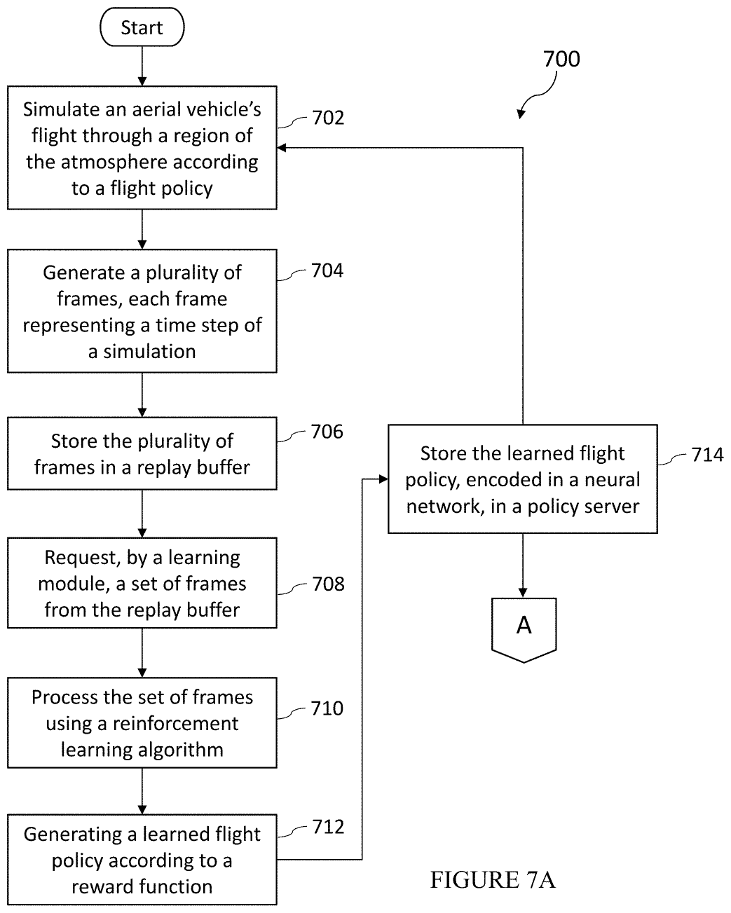

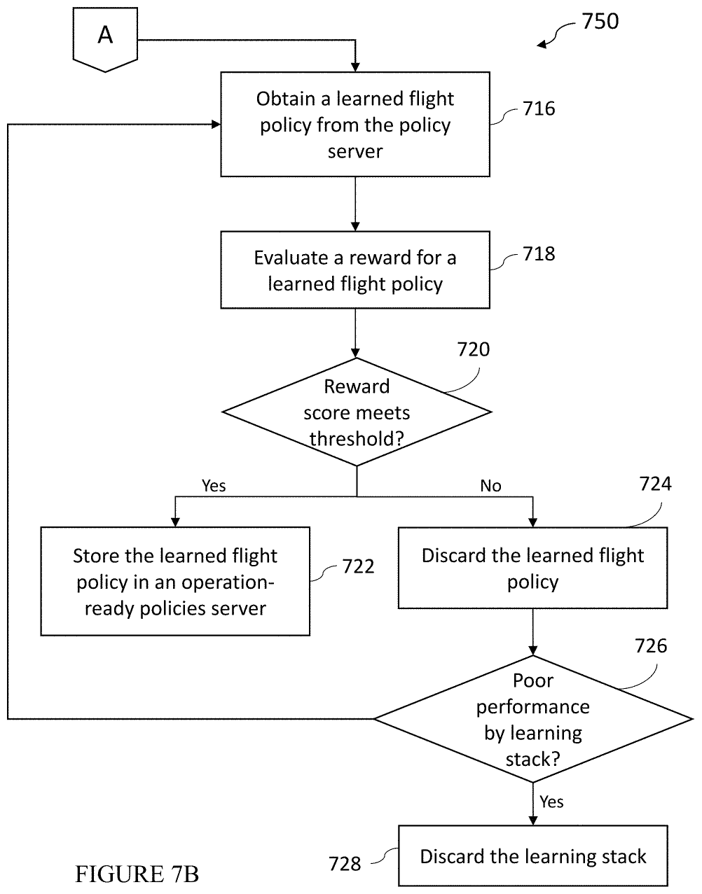

FIG. 7A is a flow diagram of an exemplary method for generating learned flight policies, in accordance with one or more embodiments. Method 700 may start with simulating an aerial vehicle's flight through a region of the atmosphere according to a flight policy at step 702. The flight policy may be an existing flight policy stored in a policy server and may be a learned flight policy previously output and provided by a learning module, as described herein. The simulation may be performed by one or more simulators in a simulation module, as described herein. In some examples, a simulation may begin with causing the aerial vehicle to perform random actions to generate feature vectors characterizing the simulation.

The simulation module may generate a plurality of frames, each frame representing a time step of a simulation at step 704, each frame comprising a feature vector representing a set of features of the aerial vehicle state and environment in said time step, wherein actions taken in each simulation in said time step correspond to a feature vector of a frame, and the resulting time step captured in the frame is rewarded for the behavior (i.e., the actions taken). At step 706, the plurality of frames may be stored in a replay buffer, the replay buffer configured to provide a random or scrambled set of frames (e.g., to disrupt the plurality of frames from their original time sequence order) for input into a learning module. As described herein, the replay buffer may comprise one or more buffers.

The method may continue, at step 708, with requesting, by a learning module, a set of frames from the replay buffer. The learning module may comprise a deep reinforcement architecture, as described above. The learning module may process the set of frames using a reinforcement learning algorithm at step 710, in order to then generate a learned flight policy that is scored according to a reward function defined for that learning module at step 712. The learned flight policy, encoded in a neural network, may be stored in a policy server at step 714.

Turning to FIG. 7B, method 750 is an exemplary method for evaluating learned flight policies and learning systems, in accordance with one or more embodiments. A learned flight policy may be obtained from the policy server at step 716, and a reward for the learned flight policy may be evaluated at step 718. As discussed above, an evaluation server (e.g., evaluation server 512) may run a set of simulations on a learned flight policy to evaluate its performance. At 720, a determination may be made as to whether the reward for the learned flight policy meets or exceeds a performance threshold (e.g., a threshold for operation-ready flight policies). If yes, the learned flight policy that was evaluated may be stored in an operation-ready policies server at step 722. If no, the learned flight policy may be discarded at step 724. At step 726, an evaluation server (e.g., evaluation server 512) may further determine whether a learning system or set of learning systems (i.e., learning stack) that produced the discarded learned flight policy is performing poorly. For example, an evaluation server may determine that a number of previously-evaluated learned flight policies resulting from the same learning system or stack also have been discarded. In another example, an evaluation server may determine that a number of previously-evaluated learned flight policies resulting from the same learning system or stack have met a poor-performance threshold. If yes, the learning system or stack from which the discarded learned flight policy resulted is performing poorly, the evaluation server may send feedback through the system to discard said poor performing learning system or stack at step 728. Whether or not the learning stack is performing poorly, the evaluation server may continue to obtain and evaluate learned flight policies.

A threshold may be predetermined to define whether a learned flight policy is high performing or low performing, and said threshold may comprise one or more thresholds used to define more granular performance categories (e.g., high performing threshold, very high performing threshold, low performing threshold, medium performing threshold, simulation-ready threshold, operation-ready threshold, discard threshold, anomalous threshold, and others, any of which may be a value-based threshold wherein the score comprises a value or a distribution-based threshold wherein the score comprises a probability distribution).

In an alternative embodiment, in some examples, the learning module itself may determine whether a threshold is met (i.e., the score for the learned flight policy meets or exceeds the threshold). The learned flight policy, which may be encoded in a neural network, that meets or exceeds said threshold may be stored in the policy server configured to store neural networks, at step 714. Once the learned flight policy is stored in the policy server, it may be provided to a simulation module, or pulled by a simulation module from the policy server, to run further simulations. If the threshold is not met (i.e., the score for the learned flight policy falls below the threshold), the learned flight policy may be discarded. Where the score comprises a value, the value score will be evaluated against a predetermined threshold value. Where the score comprises a probability distribution or distribution of rewards, the score may be evaluated against a predetermined distribution threshold.

In some examples, the operation-ready threshold for storing in the operation-ready policies server may be different from other thresholds, e.g., for storing in a normal policies server (e.g., if the learned flight policy score meets or exceeds a different and higher threshold). In still other examples, methods 700 and 750 may include evaluating a learned flight policy score against still other thresholds to gate the grouping and treating of learned flight policies in other ways.

Method 700 may be performed by flight policy training system 500 and method 750 may be performed by a flight policy training system 550, either or both of which may be implemented in a distributed computing system such as distributed computing system 400. In some examples, method 700 may be performed as a training loop in each of a plurality of training systems, such as in a meta-learning system 600. Method 750 also may be performed as part of a training loop in a meta-learning system 600.

In still other embodiments, methods 700 and 750 may be implemented using real world flight data or other sources of flight data, rather than simulations. Therefore, the training methods described herein may be performed using simulated data, historical data, fresh data collected during operation, or a mixture of these, to generate input for a learning module.

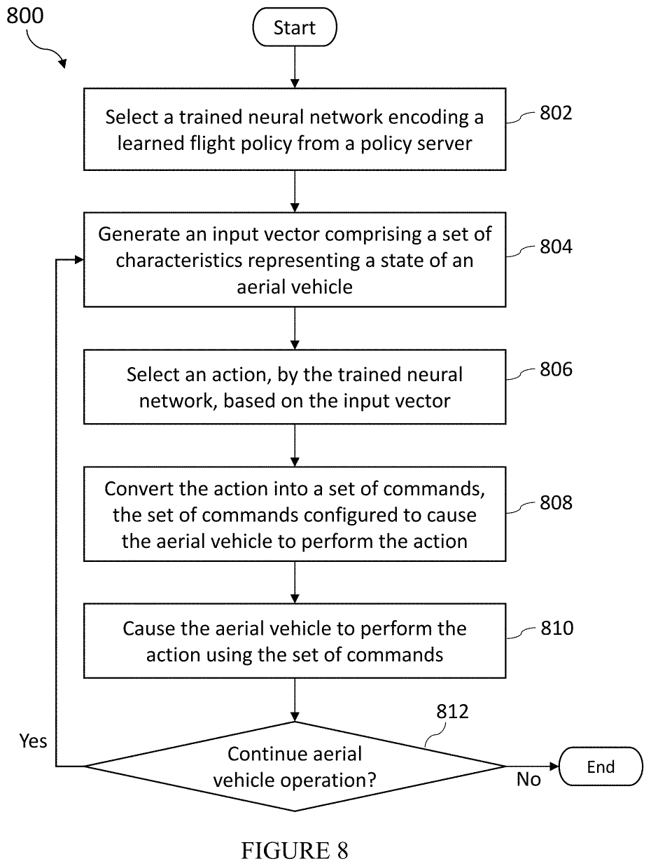

FIG. 8 is a flow diagram of an exemplary method for deploying a learned flight policy in an operational aerial vehicle system. Method 800 may start with selecting a trained neural network encoding a learned flight policy from a policy server at step 802. An input vector comprising a set of characteristics representing a state of an aerial vehicle may be generated at step 804. In some examples, an input vector may comprise a feature vector, as described above. In some examples, an input vector may comprise more than a characterization of an aerial vehicle's physical and operational state (e.g., battery levels, location, pose, speed, weight, dimensions, software version, hardware version, among others), but also may include one or more of the following environmental inputs: sensor inputs (e.g., measuring temperature, pressure, humidity, precipitation, etc.), weather forecasts, map information, air traffic information, date and time.

An action may be selected by the trained neural network based on the input vector at step 806. The action may be converted into a set of commands, at step 808, the set of commands configured to cause the aerial vehicle to perform the action. For example, an action “descend” or “down” may be converted to a set of commands that includes spinning an ACS fan motor of the aerial vehicle at a predetermined number of watts. A control system, as described herein, may then cause the aerial vehicle to perform the action using the set of commands at step 810. In some examples, a determination may be made whether the aerial vehicle operation should continue at step 812. If yes, method 800 may return to step 804 to generate further input vectors to select further actions. If no, method 800 may end.

It would be recognized by a person of ordinary skill in the art that some or all of the steps of methods 700 and 800, as described above, may be performed in a different order or sequence, repeated, and/or omitted without departing from the scope of the present disclosure.

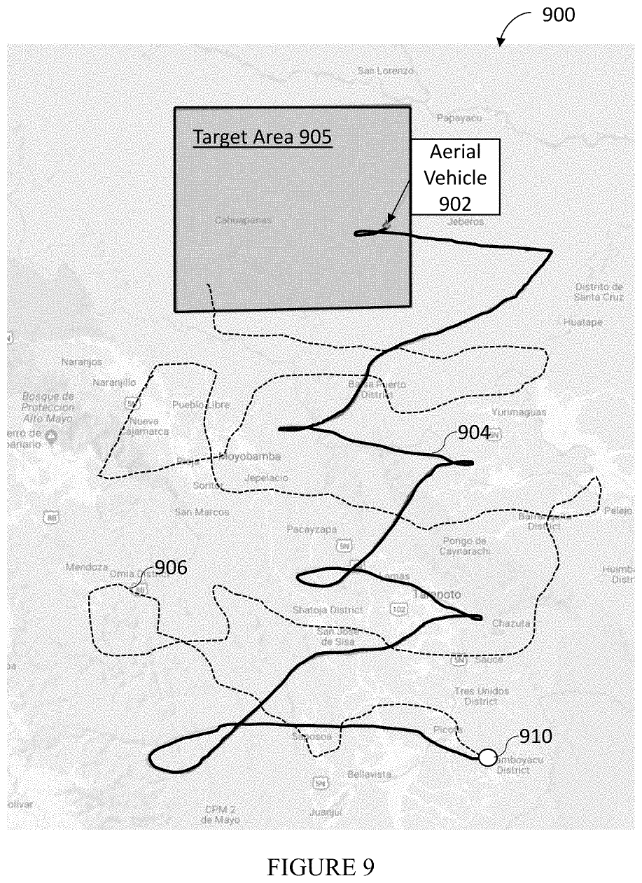

FIG. 9 is a map showing a flight path resulting from controlling an aerial vehicle using a learned flight policy, according to one or more embodiments described herein. Map 900 shows an aerial vehicle 902 having navigated a path 904 from a starting location 910 to within a target area 905 (e.g., a radius or area surrounding a target location) using a learned flight policy as described herein. Map 900 further shows a path 906 that may otherwise have been taken by aerial vehicle 902 or another aerial vehicle using a conventional, or less optimal flight policy. As shown, path 904 may have resulted from a high performing learned flight policy, and may be more efficient than path 906 in a variety of ways, including less distance traveled to target area 905, less power consumption in traveling to target area 905, better avoidance of unauthorized areas or regions of map 900, better avoidance of risky weather conditions (i.e., planning and flying a path through lower risk weather conditions), and in achieving other objectives described herein. In other examples, although not shown, aerial vehicle 902 also may be able to remain within target area 905 for a longer period of time using said learned flight policy as described herein.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A computing system for generating a learned flight policy for an aerial vehicle, the system comprising:
one or more computers and one or more storage devices, the one or more storage devices storing instructions that when executed cause the one or more computers to implement:
a simulator configured to produce a plurality of simulations of a flight of the aerial vehicle in a region of an atmosphere;
a replay buffer configured to store a plurality of frames of the plurality of simulations;
a learning module comprising a deep reinforcement learning architecture configured to, by a reinforcement learning algorithm, process an input comprising a set of frames, and output a neural network encoding a learned flight policy.

2. The system of claim 1, wherein a reward function is defined in the deep reinforcement learning architecture, the reward function being used by the learning module to score the learned flight policy.

3. The system of claim 1, wherein the reward function is defined in order to achieve an objective relating to navigation of the aerial vehicle.

4. The system of claim 1, wherein the reward function is defined in order to achieve an objective relating to an operation of the aerial vehicle.

5. The system of claim 1, further comprising a flight policy server configured to store the neural network encoding the learned flight policy.

6. The system of claim 1, further comprising an operation-ready policies server configured to store the neural network encoding the learned flight policy when the learned flight policy meets or exceeds an operation-ready or equivalent threshold score.

7. The system of claim 1, wherein each simulation of the plurality of simulations comprises a plurality of frames, and each frame of the plurality of frames represents a time step of a corresponding simulation.

8. The system of claim 7, wherein each frame comprises a feature vector representing a plurality of features of the corresponding simulation.

9. The system of claim 8, wherein a subset of the plurality of features is an operational feature of the corresponding simulation.

10. The system of claim 8, wherein a subset of the plurality of features is an environmental feature of the corresponding simulation.

11. The system of claim 1, wherein the aerial vehicle comprises a high altitude lighter than air vehicle.

12. The system of claim 1, wherein the aerial vehicle comprises a high altitude fixed-wing vehicle.

13. The system of claim 1, wherein the replay buffer further is configured to provide an arbitrary subset of the plurality of frames to be randomly sampled by the learning module.

14. A meta-learning system for training a plurality of neural networks encoding a plurality of learned flight policies, the system comprising:
a plurality of learning systems, each learning system comprising:
a simulation module comprising a plurality of simulators configured to run flight simulations,
a replay buffer configured to store a plurality of frames of the plurality of simulations and to provide an arbitrary subset of the plurality of frames to be randomly sampled, and
a learning module comprising a deep reinforcement learning architecture, the learning module configured to process an input comprising a set of frames, and output a neural network encoding a learned flight policy, wherein the neural network is one of the plurality of neural networks encoding the plurality of learned flight policies;
a coordinator configured to provide an instruction to each of the plurality of learning systems comprising a parameter and a start time; and
an evaluation server configured to evaluate a resulting reward from a learned flight policy generated by one of the plurality of learning systems.

15. The meta-learning system of claim 14, wherein the learning module is further configured to score the learned flight policy by a reward function corresponding to an objective of the learning system, one of the set of parameters being the objective.

16. The meta-learning system of claim 15, further comprising an operation-ready policies server configured to store the neural network encoding the learned flight policy when a reward score for the learned flight policy meets or exceeds an operation-ready or equivalent threshold.

17. A computer-implemented method for training a flight policy for an aerial vehicle, the method comprising:
simulating, by a simulation module comprising one or more simulators, an aerial vehicle's flight through a region of the atmosphere according to a flight policy;
generating a plurality of frames, each frame representing a time step of a simulation produced by the one or more simulators;
storing the plurality of frames, each frame including a feature vector characterizing a plurality of features and representing a given situation at the time step of the simulation;
requesting, by a learning module implementing a reinforcement learning algorithm, a set of frames from the replay buffer;
processing, by the learning module, the set of frames using the reinforcement learning algorithm;
generating, by the learning module, a neural network encoding a learned flight policy; and
storing the learned flight policy in a policy server, the flight policy being encoded in a neural network.

18. The method of claim 17, further comprising evaluating the neural network encoding the learned flight policy according to a threshold.

19. The method of claim 17, wherein the set of frames is provided to the learning module in a random order.

20. The method of claim 17, wherein the learned flight policy is configured to output an action for the aerial vehicle in the given situation.

21. The method of claim 17, wherein the learned flight policy is configured to output a representation of an action for the aerial vehicle in the given situation.

22. The method of claim 17, wherein the learned flight policy is configured to output a command for the aerial vehicle in the given situation.

23. The method of claim 17, wherein at least one of the plurality of features is an operational feature of the simulation.

24. The method of claim 17, wherein at least one of the plurality of features is an environmental feature of the simulation.
